(19) United States
(12) Patent Application Publication
(10) Pub. No.: US 2024/0312729 A1
(43) Pub. Date: Sep. 19, 2024

(54) INFILTRATION AND DRYING UNDER PRESSURE FOR CONDUCTIVE POLYMER COATING ON POROUS SUBSTRATES

(71) Applicant: SARAS MICRO DEVICES, INC., Chandler, AZ (US)

(72) Inventors: JEN-CHWEN LIN, Chandler, AZ (US); VENKATESH SUNDARAM, Chandler, AZ (US); DEWEI ZHU, Chandler, AZ (US); KYLE DASCH, Chandler, AZ (US); RAJESH GOPALASWAMY, Arizona, CA (US); MARKONDEYARAJ PULUGURTHA, Chandler, AZ (US)

(21) Appl. No.: 18/280,641

(22) PCT Filed: Apr. 5, 2022
(86) PCT No.: PCT/US2022/027691

§ 371 Date: Sep. 6, 2023

Related U.S. Application Data
(60) Provisional application No. 63/183,700, filed on May 4, 2021.

(51) Int. Cl. H01G 11/84; H01G 11/68; H01G 11/70

(52) U.S. Cl. CPC H01G 11/84; H01G 11/68; H01G 11/70

(57) ABSTRACT

Described herein are methods for coating porous substrates with a polymer and for drying or curing polymers at conditions different from ambient pressure conditions. The disclosed methods utilize a process of pressure infiltration of a polymer solution into pores of the porous substrate, which can result in filling very small pores of the porous substrate to a high volumetric degree, such as up to 100%, in a relatively short amount of time and using a relatively short number of process steps, providing for high coverage and intimate contact between the polymer and the surface of the porous substrate, including inside pores of the porous substrate.

### CROSS-REFERENCE TO RELATED APPLICATIONS

The present application claims priority to PCT Application No. PCT/US2022/027691 entitled INFILTRATION AND DRYING UNDER PRESSURE FOR CONDUCTIVE POLYMER COATING ON POROUS SUBSTRATES filed Apr. 5, 2022, and U.S. Provisional Patent Application Ser. No. 63/183,700 entitled INFILTRATION AND DRYING UNDER PRESSURE FOR CONDUCTIVE POLYMER COATING ON POROUS SUBSTRATES filed May 4, 2021, the disclosures of which are incorporated herein by reference.

### STATEMENT RE: FEDERALLY SPONSORED RESEARCH/DEVELOPMENT

Not Applicable

### BACKGROUND

### 1. Field of the Invention

The present disclosure relates to coating processes generally and more specifically to techniques for coating and filling pores in a porous substrate with a polymer, such as a conductive polymer used to fill pores in a porous substrate.

### 2. Description of the Related Art

Capacitors are an important part of many integrated and embedded circuits, and are commonly used as energy storage structures, filters, or as specific components of complex circuits. Capacitors generally include high surface area to achieve high capacitance values and are commonly arranged as a pair of thin electrodes separated by a dielectric and rolled into a tight cylindrical structure to optimize the surface area per unit volume. They are also made as deep trenches in silicon to benefit from more surface area, or as layers of dielectric and metal stacked and connected to each other to benefit from both permittivity and surface area.

### BRIEF SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In an aspect, the present disclosure provides methods for coating porous substrates with a polymer and for filling pores of the porous substrate with the polymer, such as to a high volumetric degree (e.g., up to 100%). The disclosed methods include use of elevated pressure conditions to aid in infiltration of pores of the porous substrate with the polymer solution, which may be useful for increasing the rate and extent of filling the pores and for reducing the total number of process steps needed to fill the pores with the polymer.

In some examples, methods of this aspect may comprise immersing a porous substrate in a polymer solution, the polymer solution comprising a conductive polymer or a prepolymer of the conductive polymer; subjecting the porous substrate and polymer solution to a first pressure greater than ambient pressure; holding the porous substrate in the polymer solution at the first pressure for a first time duration; withdrawing the porous substrate from the polymer solution; and drying the porous substrate or curing the prepolymer of the conductive polymer. In various examples, 1% to 100% of a volume of pores of the porous substrate are filled with the conductive polymer upon the drying or curing. The immersing, the subjecting, the holding, the withdrawing, and/or the drying or curing may optionally be repeated one or more times.

In some examples, a method of this aspect may further comprise subjecting the porous substrate to a second pressure less than ambient pressure, such as prior to immersing the porous substrate in the polymer solution, while the porous substrate is immersed in the polymer solution, or after withdrawing the porous substrate from the polymer solution.

Optionally, the polymer solution is a first polymer solution and the conductive polymer is a first conductive polymer, and the method further comprises immersing the porous substrate in a second polymer solution, the second polymer solution comprising a second conductive polymer or a prepolymer of the second conductive polymer; withdrawing the porous substrate from the second polymer solution; and drying the porous substrate or curing the prepolymer of the second conductive polymer. In some examples, such a method may result in the second conductive polymer being coated onto the first polymer.

Other objects and advantages will be apparent from the following detailed description of non-limiting examples.

### BRIEF DESCRIPTION OF THE DRAWINGS

These and other features and advantages of the various embodiments disclosed herein will be better understood with respect to the following description and drawings, in which:

FIG. 1A is a schematic illustration showing a porous substrate prior to immersion in a polymer solution.

FIG. 1B is a schematic illustration showing a porous substrate immersed in a polymer solution and subjected to pressure conditions different from ambient pressure

FIG. 1C is a schematic illustration showing a porous substrate being withdrawn from a polymer solution.

FIG. 1D is a schematic illustration showing a porous substrate being subjected to drying or curing conditions and showing pores filled with a conductive polymer.

FIG. 2A is a schematic illustration showing a porous substrate with pores filled with a conductive polymer prior to immersion in a second polymer solution.

FIG. 2B is a schematic illustration showing a porous substrate with pores filled with a conductive polymer immersed in a second polymer solution and subjected to pressure conditions different from ambient pressure.

FIG. 2C is a schematic illustration showing a porous substrate with pores filled with a conductive polymer being withdrawn from a second polymer solution.

FIG. 2D is a schematic illustration showing a porous substrate with pores filled with a conductive polymer being subjected to drying or curing conditions and showing overcoating by a second conductive polymer.

FIG. 3 is a bar graph showing the effect of resistance with heating under pressure for a polymer having a wet film thickness of 250 pm.

Common reference numerals are used throughout the drawings and the detailed description to indicate the same elements.

### DETAILED DESCRIPTION

Described herein are methods for coating and filling porous substrates with a polymer, such as a conductive polymer, including filling pores of the porous substrate with the polymer solution. The disclosed methods can advantageously allow for filling very small pores of the porous substrate to a high volumetric degree, such as up to 100%, in a relatively short amount of time and using a relatively short number of process steps, providing for high coverage and intimate contact between the polymer and the surface of the porous substrate, including inside pores of the porous substrate.

In some cases, it may be difficult to infiltrate pores with small characteristic dimensions (e.g. cross-sectional dimensions, diameters, depths, etc.), such as from 50 nm to 50 pm, with a polymer solution. For example, gas retained in the pores, coating solution surface tension, coating solution viscosity, capillary forces, or the like, may make it difficult to completely fill the pores with a polymer solution. The disclosed methods advantageously allow for efficient filling of pores of the porous substrate by subjecting the porous substrate to elevated pressure conditions while the substrate is immersed in a polymer solution. The elevated pressure can result in improved infiltration of pores in the porous substrate to a high degree, even when the pores are very small, such as having the characteristic dimensions noted above.

When the porous substrate is a conductive material coated with a dielectric coating, or a porous dielectric coating, such as an oxide, on a conductive material, the porous substrate can be used as a component of a capacitor having a high surface area, such as where surface areas inside the pores contribute to the total surface area. The conductive material can provide one electrode of the capacitor, while the second electrode of the capacitor can be provided by a conductive polymer filling pores of the substrate, with the dielectric coating providing a close, yet electrically insulating, separation between the conductive material and the conductive polymer. Many metals may be suitable for the conductive material, and aluminum may be particularly advantageous, such as due to its high conductivity and ability to rapidly and completely form a strong oxide coating, providing a very thin dielectric layer providing good electrical isolation. In one embodiment, a porous aluminum is made by etching then anodizing aluminum oxide conformally. In another embodiment, the aluminum substrate can be coated with aluminum oxide powder to form a porous oxide layer. For example, surfaces of aluminum foil can be modified using a variety of techniques to achieve a highly porous character with small pore sizes and achieve a high total surface area. In some specific examples, aluminum foil surfaces can be subjected to tunnel etching and anodization processes to form highly porous tunnel etched surfaces with large surface areas having a conformal dielectric coating of aluminum oxide. Such a porous substrate can be coated with a conductive polymer using the techniques described herein to prepare high capacitance electrolytic capacitors, which can be used in a variety of applications, such as described in U.S. Provisional Application No. 62/971,026, filed on Feb. 6, 2020, U.S. Provisional Application 62/704,941, filed on Jun. 3, 2020, U.S. Provisional Application 63/198,243, filed on Oct. 6, 2020, U.S. Provisional Application 63/199,229, filed on Dec. 15, 2020, PCT Application No. PCT/US2021/016738, filed on Feb. 5, 2021, and PCT Application No. PCT/US2021/016757, filed on Feb. 5, 2021, hereby incorporated by reference in their entireties.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure of “ambient conditions” or “ambient pressure” can be from about 975 mbar to about 1050 mbar, such as about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt.

As used herein, the meaning of “a,” “an,” and “the” includes singular and plural references unless the context clearly dictates otherwise.

Described herein are methods of infiltrating porous substrates with a polymer. Without limitation, porous substrates useful in the disclosed methods can comprise any suitable material, including metals, such as aluminum, aluminum alloys, magnesium, magnesium alloys, magnesium composites, and steel, among others, polymeric or plastic materials, glass, dielectrics, or other inorganic materials, and silicon or other semiconductor materials. In some examples, the metals for use in the methods described herein include aluminum alloys, for example, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 5xxx series aluminum alloys. In some examples, the materials for use in the methods described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal or combination of materials.

The porous substrate can have any suitable porous structure, prepared by any suitable technique. In some examples, porous substrates may comprise materials subjected to tunnel etching to create a network of tunnels in the surface. In some examples, porous substrates may comprise materials subjected to glancing angle deposition or atomic layer deposition, such as using a configuration to generate a plurality of raised and/or recessed regions. In some examples, porous substrates may comprise a conductive substrate in which conductive powders are deposited on the conductive substrate and mechanically and electrically integrated with the conductive substrate, such as by a sintering process, to create a high surface-area conductive substrate. In some examples, porous substrates may be a substrate subjected to one or more masking and/or etching processes, such as commonly used in microelectronics, semiconductor, and/or microfabrication manufacturing. In some examples, porous substrates may comprise an aluminum foil with a 3D network of interconnected pores having a conformal aluminum oxide coating.

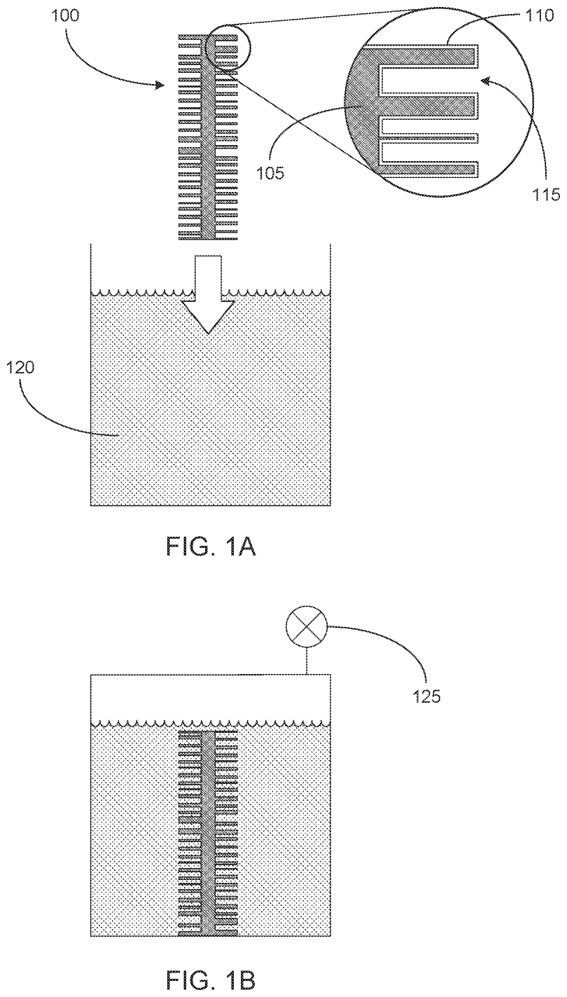

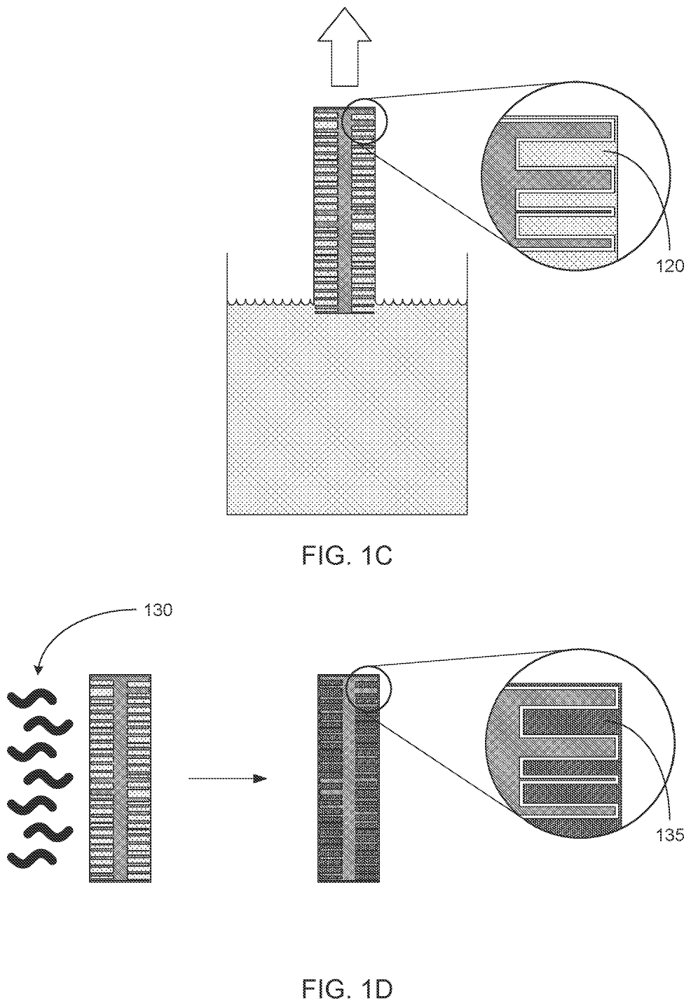

FIGS. 1A, 1B, 1C, and ID provide an overview of aspects of an example method of infiltrating a porous substrate with a polymer. FIG. 1A shows a porous substrate 100 being immersed into a polymer solution 120. An expanded inset of FIG. 1A shows an example for the structure of porous substrate 100, where porous substrate comprises a tunnel etched aluminum foil substrate 105 with a conformal dielectric coating 110 thereon, and including a plurality of pores 115. Any suitable polymers or prepolymers may be used to fill the pores 115 of the porous substrate 100. In some examples, polymer solution 120 may comprise a conductive polymer or a prepolymer of a conductive polymer, such as dissolved or suspended in a solvent, such as an evaporable solvent, like ethanol, methanol, water, or acetone. Example polymers include, but are not limited to polypyrrole, a polythiophene, a polyaniline, a polyacetylene, a polyphenylene, a poly(p-phenylene-vinylene), PEDOT:PSS (poly(3,4-ethylenedioxythiophene) polystyrene sulfonate), or P3HT (poly(3-hexylthiophene-2,5-diyl)) or wherein the prepolymer comprises a prepolymer of one or more of a polypyrrole, a polythiophene, a polyaniline, a polyacetylene, a polyphenylene, a poly(p-phenylene-vinylene), PEDOT:PSS (poly(3,4-ethylenedioxythiophene) polystyrene sulfonate), or P3HT (poly(3-hexylthiophene-2,5-diyl)). Use of a conductive polymer and a conductive porous substrate may be advantageous for use of the system as a capacitor.

The immersion process may optionally be performed at a controllable rate. In some examples, the immersion rate may be from about 1 mm/min to about 500 mm/min, such as from 1 mm/min to 5 mm/min, from 5 mm/min to 10 mm/min, from 10 mm/min to 50 mm/min, from 50 mm/min to 100 mm/min, or from 100 mm/min to 500 mm/min. During the immersion, the polymer solution 120 may be held at any suitable temperature, such as about room temperature or from about 5° C. to about 95° C. In some cases, the useful range of temperatures of the polymer solution 120 may be dictated by the composition of the polymer solution 120 or components thereof, such as the polymer, the prepolymer, the solvent, or the like. Advantageously, the porous substrate 100 may be completely immersed in the polymer solution 120, though in some cases it may be desirable to retain at least a portion of the porous substrate 100 above a surface of the polymer solution 120.

While immersed in the polymer solution 120, the porous substrate 100 and the polymer solution 120 may be subjected to pressure conditions different from ambient pressure, as schematically illustrated in FIG. 1B where the vessel containing polymer solution 120 is fitted with a lid and a pressure sensor 125. For example, in some cases the porous substrate 100 and the polymer solution 120 may be subjected to elevated pressure conditions. The pressure conditions above ambient may be from about 0.1 atm to about 12 atm above ambient pressure, such as from 0.1 atm to 0.2 atm, from 0.2 atm to 0.3 atm, from 0.3 atm to 0.4 atm, from 0.4 atm to 0.5 atm, from 0.5 atm to 1 atm, from 1 atm to 2 atm, from 2 atm to 3 atm, from 3 atm to 4 atm, from 4 atm to 5 atm, from 5 atm to 6 atm, from 6 atm to 7 atm, from 7 atm to 8 atm, from 8 atm to 9 atm, from 9 atm to 10 atm, from 10 atm to 11 atm, or from 11 atm to 12 atm above ambient pressure. The porous substrate 100 and the polymer solution 120 may be subjected to the elevated pressure conditions for a specific time duration from about 10 seconds to about 240 seconds, such as from 10 seconds to 20 seconds, from 20 seconds to 30 seconds, from 30 seconds to 40 seconds, from 40 seconds to 50 seconds, from 50 seconds to 60 seconds, from 60 seconds to 70 seconds, from 70 seconds to 80 seconds, from 80 seconds to 90 seconds, from 90 seconds to 100 seconds, from 100 seconds to 120 seconds, from 120 seconds to 140 seconds, from 140 seconds to 160 seconds, from 160 seconds to 180 seconds, from 180 seconds to 200 seconds, from 200 seconds to 220 seconds, or from 220 seconds to 240 seconds.

As another example, in some cases the porous substrate 100 and/or the polymer solution 120 may be subjected to vacuum conditions, reduced pressure conditions, or pressure below ambient. The pressure conditions below ambient may be from about 0.1 atm to about 0.99 atm below ambient pressure, such as from 0.1 atm to 0.2 atm, from 0.2 atm to 0.3 atm, from 0.3 atm to 0.4 atm, from 0.4 atm to 0.5 atm, from 0.5 atm to 0.6 atm, from 0.6 atm to 0.7 atm, from 0.7 atm to 0.8 atm, from 0.8 atm to 0.9 atm, from 0.9 atm to 0.95 atm, or from 0.95 atm to 0.99 atm below ambient pressure. In some examples, the pressure conditions during the immersion may cycle from ambient conditions to elevated pressure conditions to reduced pressure conditions one or more times, such as 1 time, 2 times, 3 times, 4 times, or 5 times, or more. In some examples, the pressure conditions during the immersion may cycle from ambient conditions to reduced pressure conditions to ambient pressure conditions one or more times, such as 1 time, 2 times, 3 times, 4 times, or 5 times, or more. In some cases, the porous substrate 100 may be subjected to the reduced pressure conditions prior to immersion in the polymer solution 120, while immersed in the polymer solution 120, and/or after withdrawal from the polymer solution 120.

After subjecting the porous substrate 100 and polymer solution 120 to pressure conditions different from ambient pressure, the porous substrate 100 is withdrawn from the polymer solution 120, such as schematically depicted in FIG. 1C. The expanded inset of FIG. 1C shows an example where pores 115 of porous substrate 100 after withdrawing are filled with the polymer solution 120. The withdrawal process may optionally be performed at a controllable rate. In some examples, the withdrawal rate may be from about 1 mm/min to about 500 mm/min, such as from 1 mm/min to 5 mm/min, from 5 mm/min to 10 mm/min, from 10 mm/min to 50 mm/min, from 50 mm/min to 100 mm/min, or from 100 mm/min to 500 mm/min.

In some examples, withdrawing the porous substrate 100 from the polymer solution 120 may comprise a multi-step process, such as where the porous substrate 100 is raised such that a majority of an area of the porous substrate is above a surface of the polymer solution 120 while a portion of the porous substrate 100 remains below a surface of the polymer solution. In some cases, the porous substrate 100 may be held at such a position for a period of about 10 second to about 240 seconds, such as from 10 seconds to 20 seconds, from 20 seconds to 30 seconds, from 30 seconds to 40 seconds, from 40 seconds to 50 seconds, from 50 seconds to 60 seconds, from 60 seconds to 70 seconds, from 70 seconds to 80 seconds, from 80 seconds to 90 seconds, from 90 seconds to 100 seconds, from 100 seconds to 120 seconds, from 120 seconds to 140 seconds, from 140 seconds to 160 seconds, from 160 seconds to 180 seconds, from 180 seconds to 200 seconds, from 200 seconds to 220 seconds, or from 220 seconds to 240 seconds. Following the hold, the porous substrate 100 may be raised further so that it is fully above a surface of the polymer solution 120. In some examples, the two raising steps described may be performed at different rates, such as where the first part of withdrawing occurs at a faster rate than the second part of withdrawing.

After withdrawing porous substrate 100 from the polymer solution 120, the porous substrate 100 with pores 115 filled with polymer solution 120 may be subjected to drying or curing conditions 130, as schematically illustrated in FIG. 1D, so as to result in pores 115 of porous substrate 100 filled with polymer 135 after drying or curing.

Without limitation, the drying or curing conditions 130 may comprise one or more of heating the porous substrate to a first temperature greater than ambient temperature, holding the porous substrate at the first temperature for a second time duration, subjecting the porous substrate to a heating process, subjecting the porous substrate to a second pressure less than or greater than ambient pressure, holding the porous substrate at the second pressure for a third time duration, subjecting the porous substrate to a third pressure less than or greater than ambient pressure, holding the porous substrate at the third pressure for a fourth time duration, or exposing the porous substrate to ultraviolet light. Optionally, if the second pressure is less than ambient pressure, the third pressure is greater than ambient pressure. Optionally, if the second pressure is greater than ambient pressure, the third pressure is less than ambient pressure. In some examples, the first temperature is from about 70° C. to about 260° C., such as from 70° C. to 80° C., from 80° C. to 90° C., from 90° C. to 100° C., from 100° C. to 120° C., from 120° C. to 140° C., from 140° C. to 160° C., from 160° C. to 180° C., from 180° C. to 200° C., from 200° C. to 220° C., from 220° C. to 240° C., or from 240° C. to 260° C. In some examples, the second time duration is from 1 minute to 30 minutes, such as from 1 minute to 5 minutes, from 5 minutes to 10 minutes, from 10 minutes to 15 minutes, from 15 minutes to 20 minutes, from 20 minutes to 25 minutes, or from 25 minutes to 30 minutes. In some examples, the second pressure is from 0.1 atm to 0.99 atm below ambient pressure, such as from 0.1 atm to 0.2 atm, from 0.2 atm to 0.3 atm, from 0.3 atm to 0.4 atm, from 0.4 atm to 0.5 atm, from 0.5 atm to 0.6 atm, from 0.6 atm to 0.7 atm, from 0.7 atm to 0.8 atm, from 0.8 atm to 0.9 atm, from 0.9 atm to 0.95 atm, or from 0.95 atm to 0.99 atm below ambient pressure. In some examples, the second pressure is from 0.1 atm to 12 atm above ambient pressure, such as from 0.1 atm to 0.2 atm, from 0.2 atm to 0.3 atm, from 0.3 atm to 0.4 atm, from 0.4 atm to 0.5 atm, from 0.5 atm to 1 atm, from 1 atm to 2 atm, from 2 atm to 3 atm, from 3 atm to 4 atm, from 4 atm to 5 atm, from 5 atm to 6 atm, from 6 atm to 7 atm, from 7 atm to 8 atm, from 8 atm to 9 atm, from 9 atm to 10 atm, from 10 atm to 11 atm, or from 11 atm to 12 atm above ambient pressure. In some examples, the third time duration is from 10 seconds to 30 minutes, such as from 10 seconds to 20 seconds, from 20 seconds to 30 seconds, from 30 seconds to 40 seconds, from 40 seconds to 50 seconds, from 50 seconds to 1 minute, from 1 minute to 5 minutes, from 5 minutes to 10 minutes, from 10 minutes to 15 minutes, from 15 minutes to 20 minutes, from 20 minutes to 25 minutes, or from 25 minutes to 30 minutes. In some examples, the third pressure is from 0.1 atm to 12 atm above ambient pressure, such as from 0.1 atm to 0.2 atm, from 0.2 atm to 0.3 atm, from 0.3 atm to 0.4 atm, from 0.4 atm to 0.5 atm, from 0.5 atm to 1 atm, from 1 atm to 2 atm, from 2 atm to 3 atm, from 3 atm to 4 atm, from 4 atm to 5 atm, from 5 atm to 6 atm, from 6 atm to 7 atm, from 7 atm to 8 atm, from 8 atm to 9 atm, from 9 atm to 10 atm, from 10 atm to 11 atm, or from 11 atm to 12 atm above ambient pressure. In some examples, the third pressure is from 0.1 atm to 0.99 atm below ambient pressure, such as from 0.1 atm to 0.2 atm, from 0.2 atm to 0.3 atm, from 0.3 atm to 0.4 atm, from 0.4 atm to 0.5 atm, from 0.5 atm to 0.6 atm, from 0.6 atm to 0.7 atm, from 0.7 atm to 0.8 atm, from 0.8 atm to 0.9 atm, from 0.9 atm to 0.95 atm, or from 0.95 atm to 0.99 atm below ambient pressure. In some examples, the fourth time duration is from 10 seconds to 30 minutes, such as from 10 seconds to 20 seconds, from 20 seconds to 30 seconds, from 30 seconds to 40 seconds, from 40 seconds to 50 seconds, from 50 seconds to 1 minute, from 1 minute to 5 minutes, from 5 minutes to 10 minutes, from 10 minutes to 15 minutes, from 15 minutes to 20 minutes, from 20 minutes to 25 minutes, or from 25 minutes to 30 minutes.

Although FIG. 1D shows pores 115 of porous substrate 100 completely filled with polymer 135 after drying or curing, the volume extent of filling after drying or curing may be from about 1% to about 100%, such as from 1% to 5%, from 5% to 10%, from 10% to 20%, from 20% to 30%, from 30% to 40%, from 40% to 50%, from 50% to 60%, from 60% to 70%, from 70% to 80%, from 80% to 90%, from 90% to 95%, from 95% to 99%, from 99% to 99.9%, or from 99.9% to 100%. In cases where the volume extent of filling after drying or curing is not as high as desirable, the aspects described above with respect to FIG. 1A, FIG. 1B, FIG. 1C, and FIG. 1D, including immersing the porous substrate 100 in the polymer solution 120, subjecting the porous substrate 100 and polymer solution 120 to pressure greater than ambient pressure, holding the porous substrate 100 in the polymer solution 120 at the pressure greater than for a particular time duration, withdrawing the porous substrate 100 from the polymer solution 120, and drying or curing the porous substrate 100 with pores 115 filled with polymer solution 120, may be repeated one or more times, such as from 2 to 30 times, or more. In this way, a suitable amount of volume of the pores 115 of the porous substrate 100 may be filled with the polymer 135 by repeated immersion, pressure treatment, and drying, for example.

In some cases, it may be desirable to use a second, different, polymer solution for a subsequent immersion process. For example, some polymer solutions may have physical properties that may be less compatible with filing pores of a porous substrate, such as a polymer solution with a relatively high viscosity. In such a case, the pores of a porous substrate can be filled by a first polymer solution, as described above, followed by subsequent immersion in a second polymer solution with a higher viscosity, for example, for coating the porous substrate and/or filling pores of the porous substrate with a second polymer. In some embodiments, the filling and immersion process may be used to form a continuous layer as a current collector in a capacitor.

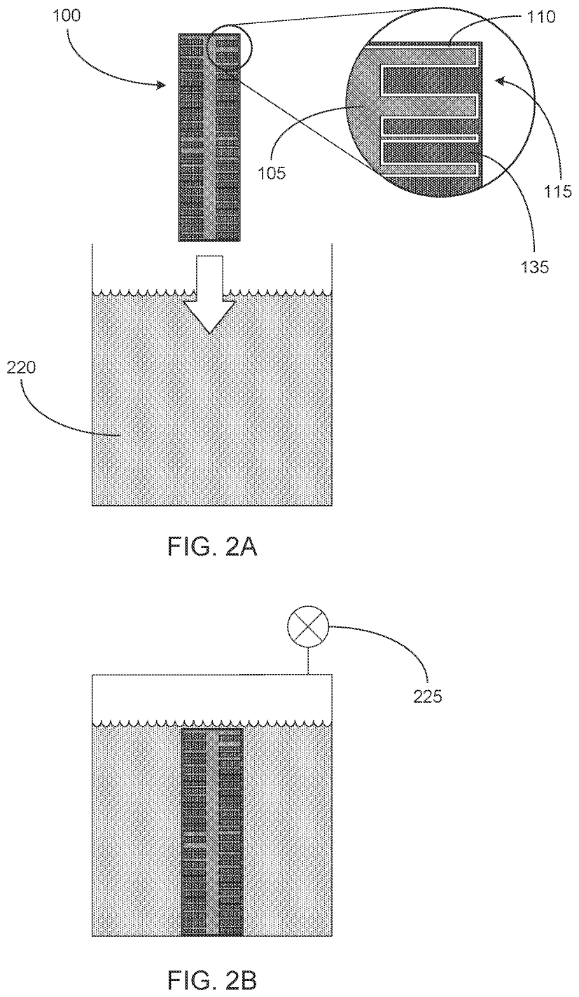

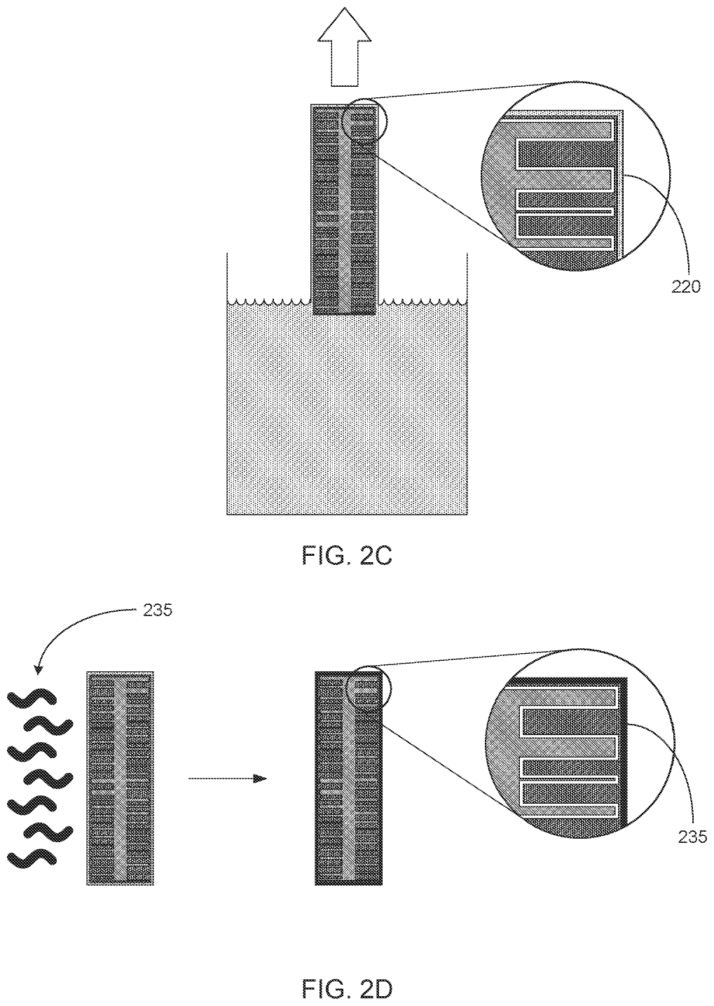

FIG. 2A shows an example, where the porous substrate 100 with pores 115 filled with the polymer 135 is immersed in a second polymer solution 220. As shown in the expanded inset of FIG. 2A, porous substrate 100 comprises a tunnel etched aluminum foil substrate 105 with a conformal dielectric coating 110 thereon, and including a plurality of pores 115 filled with the polymer 135. Optionally, tunnel etched aluminum foil substrate 105 may comprise an aluminum foil with a 3D network of interconnected pores, and the conformal dielectric coating 110 may comprise a conformal aluminum oxide coating. In some examples, second polymer solution 220 may comprise a conductive polymer or a prepolymer of a conductive polymer, such as dissolved or suspended in a solvent, such as an evaporable solvent, like ethanol, methanol, water, or acetone, and may have one or more components different from or in different concentrations as polymer solution 120 described above with reference to FIG. 1A, FIG. 1B, and FIG. 1C.

The porous substrate is shown in FIG. 2B as immersed in second polymer solution 220. The immersion process may optionally be performed at a controllable rate. In some examples, the immersion rate may be from about 1 mm/min to about 500 mm/min. During the immersion, the second polymer solution 220 may be held at any suitable temperature, such as about room temperature or from about 5° C. to about 950 C. Optionally, while immersed in the second polymer solution 220, the porous substrate 100 and the second polymer solution 220 may be subjected to pressure conditions different from ambient pressure, as schematically illustrated in FIG. 2B where the vessel containing second polymer solution 220 is fitted with a lid and a pressure sensor 225. For example, in some cases the porous substrate 100 and the second polymer solution 220 may be subjected to elevated pressure conditions, such as from about 0.1 atm to about 12 atm above ambient pressure, or to reduced pressure conditions, such as from about 0.1 atm to about 0.99 atm below ambient pressure. The pressure conditions may be maintained for a suitable time duration, such as from about 10 seconds to about 240 seconds. In some examples, the pressure conditions during the immersion may cycle from ambient conditions to elevated pressure conditions to reduced pressure conditions one or more times.

As schematically depicted in FIG. 2C, the porous substrate 100 may be withdrawn from the second polymer solution 220, such as by using a single or multiple step withdrawal process. The expanded inset of FIG. 2C shows an example where porous substrate 100 with pores 115 filled with polymer 135 is coated with the second polymer solution 220. The withdrawal process may optionally be performed at a controllable rate, such as from about 1 mm/min to about 500 mm/min.

After withdrawing porous substrate 100 from the second polymer solution 220, the porous substrate 200 with pores 115 filled with polymer 135 and coated with second polymer solution 220 may be subjected to drying or curing conditions 330, as schematically illustrated in FIG. 2D, so as to result in porous substrate 200 with pores 115 filled with polymer 135 being coated a second polymer 235 after drying or curing.

Without limitation, the drying or curing conditions 230 may be the same as or different from drying or curing conditions 130 described above with reference to FIG. 1D. For example, drying or curing conditions 230 may comprise one or more of heating the porous substrate to a temperature greater than ambient temperature, holding the porous substrate at that temperature for particular time duration, subjecting the porous substrate to a heating process, subjecting the porous substrate to a pressure less than ambient pressure, holding the porous substrate at that pressure for a particular time duration, subjecting the porous substrate to a pressure greater than ambient pressure, holding the substrate at that pressure for a particular time duration, or exposing the porous substrate to ultraviolet light. Following the process of subjecting to drying or curing conditions 230, the porous substrate 100, with pores 115 filed with polymer 135 may be coated with a second polymer 235. In some cases, the processes of immersion, optional pressure treatment, and drying or curing, may be repeated one or more times for example. Effect of Resistance with Heating Under Pressure

In one embodiment, there is described a method of reducing the resistance of the resulting polymer films described herein by heating the films under pressure. To compare the effects of heating under pressure, six samples A, B, C, D, E, and F each having a wet film thickness of 250 pm, were made. Samples A-F each have two polymer layers; however, samples A-C only had the second polymer heated under pressure whereas samples D-F had both polymers heated under pressure. The resistance of these six samples were compared against a baseline sample (X) having an identical film composition as samples A-F, but which was heated without pressure.

In one embodiment, the samples were placed into a hot oven, such as at 120° C. In another embodiment, the samples are placed into a room temperature oven, and the temperature increased to 120° C., which allows ramping the pressure before the temperature. The reason for ramping the pressure first is to prevent drying the polymer solution before pressurizing. It is also possible to place the sample into a pre-chamber for ramping the pressure to a specified value, and then to a hot oven at the specified temperature and pressure. Whether the samples are placed into a hot oven at 120° C. or ramped up to 120° C., was not found to affect the results because both are in a completely “dried” condition.

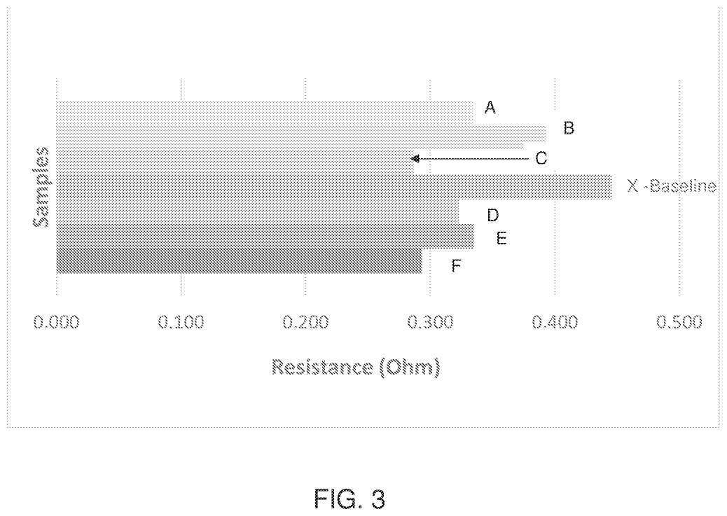

Regarding the comparative testing disclosed herein, baseline sample (X) was placed in a 120° C. oven and baked for 10 mins at ambient pressure. The oven was then air cooled to room temperature. The baseline sample was not exposed to pressure during baking. In contrast, Samples A-F were placed in a room temperature oven, which was then pressurized above ambient pressure, such as to about 8 kg/cm2 or about 7 to 8 atm. Once pressurized, the oven was heated to 120° C., where the samples were baked for 10 mins. The oven was then air cooled to room temperature. The results of these heating and baking conditions on resistance are shown in FIG. 3. As shown in FIG. 3, each of samples A-F had a lower electrical resistance than the baseline sample X.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a method comprising: immersing a porous substrate in a polymer solution, the polymer solution comprising a conductive polymer or a prepolymer of the conductive polymer; subjecting the porous substrate and polymer solution to a first pressure greater than ambient pressure; holding the porous substrate in the polymer solution at the first pressure for a first time duration; withdrawing the porous substrate from the polymer solution; and drying the porous substrate or curing the prepolymer of the conductive polymer; wherein 1% to 100% of a volume of pores of the porous substrate are filled with the conductive polymer upon the drying or curing.

Aspect 2 is the method of any previous or subsequent aspect, further comprising repeating the immersing, the subjecting, the holding, the withdrawing, and the drying or curing one or more times, wherein 2% to 100% of the volume of pores of the porous substrate are filled with the conductive polymer after the repeating.

Aspect 3 is the method of any previous or subsequent aspect, wherein the repeating comprises repeating from 2 times to 20 times.

Aspect 4 is the method of any previous or subsequent aspect, wherein immersing the porous substrate in the polymer solution occurs at a rate of from 1 mm/min to 500 mm/min.

Aspect 5 is the method of any previous or subsequent aspect, wherein the first pressure is from 0.1 atm to 12 atm above ambient pressure.

Aspect 6 is the method of any previous or subsequent aspect, wherein the first time duration is from 10 seconds to 240 seconds.

Aspect 7 is the method of any previous or subsequent aspect, wherein a temperature of the polymer solution is from 5° C. to 95° C. [57] Aspect 8 is the method of any previous or subsequent aspect, further comprising subjecting the porous substrate to a second pressure less than ambient pressure.

Aspect 9 is the method of any previous or subsequent aspect, wherein subjecting the porous substrate to the second pressure less than ambient pressure occurs prior to immersing the porous substrate in the polymer solution, while the porous substrate is immersed in the polymer solution, or after withdrawing the porous substrate from the polymer solution.

Aspect 10 is the method of any previous or subsequent aspect, wherein second pressure is from 0.1 atm to 0.99 atm below ambient pressure.

Aspect 11 is the method of any previous or subsequent aspect, wherein the drying or curing comprises one or more of: heating the porous substrate to a first temperature greater than ambient temperature; holding the porous substrate at the first temperature for a second time duration; subjecting the porous substrate to a heating process; subjecting the porous substrate to a second pressure less than or greater than ambient pressure; holding the porous substrate at the second pressure for a third time duration; subjecting the porous substrate to a third pressure less than or greater than ambient pressure; holding the porous substrate at the third pressure for a fourth time duration; or exposing the porous substrate to ultraviolet light.

Aspect 12 is the method of any previous or subsequent aspect, wherein: the first temperature is from 70° C. to 260° C.; the second time duration is from 1 minute to 30 minutes; the second pressure is from 0.1 atm to 12 atm above ambient pressure; the third time duration is from 10 seconds to 30 minutes; the third pressure is from 0.1 atm to 0.99 atm below ambient pressure; or the fourth time duration is from 10 seconds to 30 minutes.

Aspect 13 is the method of any previous or subsequent aspect, wherein: the first temperature is from 70° C. to 260° C.; the second time duration is from 1 minute to 30 minutes; the second pressure is from 0.1 atm to 0.99 atm below ambient pressure; the third time duration is from 10 seconds to 30 minutes; the third pressure is from 0.1 atm to 12 atm above ambient pressure; or the fourth time duration is from 10 seconds to 30 minutes.

Aspect 14 is the method of any previous or subsequent aspect, wherein withdrawing the porous substrate from the polymer solution occurs at a rate of from 1 mm/min to 500 mm/min.

Aspect 15 is the method of any previous or subsequent aspect, wherein withdrawing the porous substrate from the polymer solution comprises: raising the porous substrate to a first position where a majority of an area of the porous substrate is above a surface of the polymer solution while at least a portion of the area of the porous substrate remains below the surface of the polymer solution; holding the porous substrate at the first position for a second time duration; and raising the porous substrate to a second position where the porous substrate is fully above the surface of the polymer solution.

Aspect 16 is the method of any previous or subsequent aspect, wherein the second time duration is from 10 seconds to 240 seconds.

Aspect 17 is the method of any previous or subsequent aspect, wherein withdrawing the porous substrate from the polymer solution comprises: withdrawing the porous substrate at a first rate to a first position where a majority of an area of the porous substrate is above a surface of the polymer solution while at least a portion of the area of the porous substrate remains below the surface of the polymer solution; and withdrawing the porous substrate at a second rate to a second position where the porous substrate is fully above the surface of the polymer solution, wherein the first rate is faster than the second rate.

Aspect 18 is the method of any previous or subsequent aspect, wherein the porous substrate comprises a porous conductive material having a dielectric coating thereon.

Aspect 19 is the method of any previous or subsequent aspect, wherein the porous substrate comprises a substrate having one or more pores, tunnels, voids, or recesses therein, wherein the one or more pores, tunnels, voids, or recesses have cross-sectional dimensions of from 50 nm to 50 pm.

Aspect 20 is the method of any previous or subsequent aspect, wherein the porous substrate comprises a modified aluminum foil with a conformal dielectric layer thereon.

Aspect 21 is the method of any previous or subsequent aspect, wherein the porous substrate comprises an aluminum foil with a 3D network of interconnected pores having a conformal aluminum oxide coating.

Aspect 22 is the method of any previous or subsequent aspect, wherein the porous substrate comprises a tunnel-etched aluminum foil with a conformal aluminum oxide coating.

Aspect 23 is the method of any previous or subsequent aspect, wherein the conductive polymer fills 1% to 100% of a volume of tunnels in the tunnel-etched aluminum foil and is electrically separated from the tunnel-etched aluminum foil by the conformal aluminum oxide coating. [73] Aspect 24 is the method of any previous or subsequent aspect, wherein the conductive polymer comprises one or more of a polypyrrole, a polythiophene, a polyaniline, a poly acetylene, a polyphenylene, a poly(p-phenylene-vinylene), PEDOT:PSS (poly (3,4-ethylenedioxythiophene) polystyrene sulfonate), or P3HT (poly(3-hexylthiophene-2,5-diyl)) or wherein the prepolymer comprises a prepolymer of one or more of a polypyrrole, a poly thiophene, a poly aniline, a poly acetylene, a polyphenylene, a poly(p-phenylene-vinylene), PEDOT:PSS (poly(3,4-ethylenedioxythiophene) polystyrene sulfonate), or P3HT (poly(3-hexylthiophene-2,5-diyl)).

Aspect 25 is the method of any previous or subsequent aspect, wherein the polymer solution comprises one or more evaporable solvents.

Aspect 26 is the method of any previous or subsequent aspect, wherein the polymer solution is a first polymer solution and the conductive polymer is a first conductive polymer, the method further comprising: immersing the porous substrate in a second polymer solution, the second polymer solution comprising a second conductive polymer or a prepolymer of the second conductive polymer; withdrawing the porous substrate from the second polymer solution; and drying the porous substrate or curing the prepolymer of the second conductive polymer; wherein the second conductive polymer is coated onto the first conductive polymer and establishes electrical communication with the first conductive polymer upon the drying or curing.

Aspect 27 is the method of any previous or subsequent aspect, wherein the first polymer solution has a lower viscosity than the second polymer solution.

Aspect 28 is the method of any previous or subsequent aspect, wherein the first conductive polymer and the second conductive polymer are different.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1-41. (canceled)

42. A method comprising:
immersing a porous substrate in a polymer solution;
subjecting the porous substrate and polymer solution to a first pressure greater than ambient pressure;
holding the porous substrate in the polymer solution at the first pressure for a first time duration; and
withdrawing the porous substrate from the polymer solution, at least a portion of the volume of pores of the porous substrate being filled with the polymer solution after said withdrawing.

43. The method of claim 42, wherein the polymer solution comprises a conductive polymer and the method further comprises drying the porous substrate, at least a portion of the volume of pores of the porous substrate being filled with the conductive polymer after said drying.

44. The method of claim 43, wherein said drying comprises:
placing the porous substrate into a chamber;
increasing the pressure of the chamber to a second pressure above ambient pressure;
heating the chamber to a first temperature above ambient temperature when the second pressure is reached; and
holding the porous substrate at the second pressure and the first temperature.

45. The method of claim 43, further comprising repeating the immersing, the subjecting, the holding, the withdrawing, and the drying one or more times.

46. The method of claim 42, wherein the polymer solution comprises a prepolymer of a conductive polymer and the method further comprises curing the prepolymer of the conductive polymer, at least a portion of the volume of pores of the porous substrate being filled with the conductive polymer after said curing.

47. The method of claim 46, wherein said curing comprises exposing the porous substrate to ultraviolet light.

48. The method of claim 46, further comprising repeating the immersing, the subjecting, the holding, the withdrawing, and the curing one or more times.

49. The method of claim 42, further comprising controlling a rate of said immersing the porous substrate in the polymer solution.

50. The method of claim 42, wherein the first pressure is from 0.1 atm to 12 atm above ambient pressure.

51. The method of claim 42, wherein the first time duration is from 10 seconds to 240 seconds.

52. The method of claim 42, wherein a temperature of the polymer solution is from 5° C. to 95° C.

53. The method of claim 42, further comprising subjecting the porous substrate to a second pressure less than ambient pressure.

54. The method of claim 42, wherein said withdrawing the porous substrate from the polymer solution comprises:
raising the porous substrate to a first position where a majority of an area of the porous substrate is above a surface of the polymer solution while at least a portion of the area of the porous substrate remains below the surface of the polymer solution;
holding the porous substrate at the first position for a second time duration; and
raising the porous substrate to a second position where the porous substrate is fully above the surface of the polymer solution.

55. The method of claim 54, wherein the second time duration is from 10 seconds to 240 seconds.

56. The method of claim 42, further comprising controlling a rate of said withdrawing the porous substrate from the polymer solution.

57. The method of claim 56, wherein said withdrawing the porous substrate from the polymer solution comprises:
withdrawing the porous substrate at a first rate to a first position where a majority of an area of the porous substrate is above a surface of the polymer solution while at least a portion of the area of the porous substrate remains below the surface of the polymer solution; and
withdrawing the porous substrate at a second rate to a second position where the porous substrate is fully above the surface of the polymer solution, wherein the first rate is faster than the second rate.

58. The method of claim 42, wherein the polymer solution is a first polymer solution, the method further comprising:
immersing the porous substrate in a second polymer solution having a higher viscosity than the first polymer solution; and
withdrawing the porous substrate from the second polymer solution.

59. The method of claim 58, wherein the first polymer solution comprises a first conductive polymer, the second polymer solution comprises a second conductive polymer, and the method further comprises drying the porous substrate, wherein the second conductive polymer is coated onto the first conductive polymer and establishes electrical communication with the first conductive polymer after said drying.

60. A method comprising:
immersing a porous substrate in a polymer solution;
subjecting the porous substrate and polymer solution to a first pressure greater than ambient pressure;
holding the porous substrate in the polymer solution at the first pressure for a first time duration;
withdrawing the porous substrate from the polymer solution;
placing the porous substrate into a chamber;
increasing the pressure of the chamber to a second pressure above ambient pressure;
heating the chamber to a first temperature above ambient temperature when the second pressure is reached; and
holding the porous substrate at the second pressure and the first temperature.

61. A method of drying a porous substrate that has been filled and/or coated with at least one polymer by drying it while it is under pressure, the method comprising:
placing the porous substrate into a chamber;
increasing the pressure of the chamber to a pressure above ambient pressure;
heating the chamber to a temperature above ambient temperature when the pressure above ambient pressure is reached; and
holding the porous substrate at the pressure above ambient pressure and the temperature above ambient temperature.
